(19) United States
(12) Patent Application Publication
(10) Pub. No.: US 2026/0253282 A1
(43) Pub. Date: Aug. 27, 2026

(54) Generative Artificial Intelligence Configuration System for Aircraft Interior Designs

(71) Applicant: The Boeing Company, Arlington, VA (US)

(72) Inventors: Amir Afrasiabi, Laguna Niguel, CA (US); Sina Rafati, Santa Ana, CA (US); Brett M. Factory, Mountlake Terrace, WA (US)

(21) Appl. No.: 19/063,646

(22) Filed: Feb. 26, 2025

(51) Int. Cl. G06T 11/60; G06F 30/15; G06F 30/27

(52) U.S. Cl. CPC G06T 11/60; G06F 30/15; G06F 30/27; G06T 2210/04

(57) ABSTRACT

A design system comprises a computer system, a machine learning model system and a design generator. The design generator is configured to perform operations. The operations include identifying a reference image of a design of an interior of an aircraft; identifying engineering data for the design; receiving an element selection of elements in the reference image of the design for modification; generating an enhanced image of the design using the elements, the element selection, and the machine learning model system, wherein the elements in the enhanced image are enhanced elements; receiving an element modification for modifying the enhanced elements; modifying the enhanced elements using the element modification that takes into account the engineering data using the machine learning model system to form a customized image of the design with modified elements in place of enhanced elements; and displaying the customized image on a display system.

### BACKGROUND INFORMATION

### 1. Field

The present disclosure relates generally to aircraft and in particular, aircraft interior configurations.

### 2. Background

Designing interiors such as cabins for aircraft for presentation and feedback by customers is a collaborative and time-consuming process. Design engineers and three-dimensional artists collaborate to generate interior designs. The design engineers and three-dimensional artists spend large amounts of time to design and render aircraft interiors using configuration files from configuration engineering teams. These configuration files provide details such as structures, systems, and constraints. These types of files are highly technical and difficult to understand. Further, not all elements in these files are needed to create the designs and visual representations of the aircraft interiors.

After generating a design, multiplicative rations in changing the design can occur based on feedback from customers. This feedback may result in refining layouts, materials, lighting, seat configurations, and other parts of an aircraft interior design.

### SUMMARY

An embodiment of the present disclosure provides an interior design system comprising a computer system, a machine learning model system in the computer system, and a design generator in the computer system. The design generator is configured to perform operations comprising identifying a reference image of an interior design of an interior of an aircraft; identifying engineering data for the interior design; receiving an element selection of a number of elements in the reference image of the interior design for modification; generating an enhanced image of the interior design using the number of elements in the reference image, the element selection, and the machine learning model system, wherein the number of elements in the enhanced image are a number of enhanced elements; receiving an element modification for modifying the number of enhanced elements in the enhanced image; modifying the number of enhanced elements using the element modification that takes into account the engineering data using the machine learning model system to form a customized image of the interior design with a number of modified elements in place of the number of enhanced elements; and displaying the customized image on a display system.

Another embodiment of the present disclosure provides a method for generating a change to an interior design of an interior of an aircraft. A reference image of the interior design of the interior of the aircraft is identified. Engineering data for the interior design is identified. An element selection of a number of elements in the reference image of the interior design for modification is received. An enhanced image of the interior design is generated using the number of elements in the reference image, the element selection, and the machine learning model system, wherein the number of elements in the enhanced image are a number of enhanced elements. An element modification for modifying the number of enhanced elements in the enhanced image is received. The number of enhanced elements is modified using the element modification that takes into account the engineering data using the machine learning model system to form a customized image of the interior design with a number of modified elements in place of the number of enhanced elements. The customized image is displayed on a display system.

Still another embodiment of the present disclosure provides a computer program product for generating a change to an interior design of an interior of an aircraft. The computer program product comprises a set of one or more computer-readable storage media and program instructions stored on the set of one or more storage media. The program instructions are to perform operations comprising identifying a reference image of the interior design of the interior of the aircraft; identifying engineering data for the interior design; receiving an element selection of a number of elements in the reference image of the interior design for modification; generating an enhanced image of the interior design using the number of elements in the reference image, the element selection, and the machine learning model system, wherein the number of elements in the enhanced image are a number of enhanced elements; receiving an element modification for modifying the number of enhanced elements in the enhanced image; and modifying the number of enhanced elements using the element modification that takes into account the engineering data using the machine learning model system to form a customized image of the interior design with a number of modified elements in place of the number of enhanced elements; and displaying the customized image on a display system.

Yet another embodiment of the present disclosure provides an interior design system comprising a computer system; a generative artificial intelligence model system in the computer system; and a design generator in the computer system. The design generator is configured to perform operations comprising identifying a reference image of an interior design of an interior of a vehicle; identifying engineering data for the interior design; receiving an element selection of a number of elements in the reference image of the interior design for modification; generating an enhanced image of the interior design using the number of elements in the reference image, the element selection, and the machine learning model system, wherein the number of elements in the enhanced image are a number of enhanced elements; receiving an element modification for modifying the number of enhanced elements in the enhanced image; modifying the number of enhanced elements using the element modification that takes into account the engineering data using the machine learning model system to form a customized image of the interior design with a number of modified elements in place of the number of enhanced elements; and displaying the customized image on a display system.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is an illustration of a block diagram of a design environment in accordance with an illustrative embodiment;

FIG. 3 is an illustration of a process flow diagram for changing visualization of an interior design in accordance with an illustrative embodiment;

FIG. 4 is an illustration of a process flow diagram for changing visualization of an interior design in accordance with an illustrative embodiment;

FIG. 5 is an illustration of a process flow for customizing an interior of a passenger cabin in accordance with an illustrative embodiment;

FIG. 6 is an illustration of a process flow for customizing an interior of a passenger cabin in accordance with an illustrative embodiment;

FIG. 7 is an illustration of a process flow for customizing an aircraft structure in accordance with an illustrative embodiment;

FIG. 8 is an illustration of a flowchart of a process for generating a change to a design of an interior of an aircraft in accordance with an illustrative embodiment;

FIG. 9 is an illustration of a flowchart of a process for displaying an enhanced image in accordance with an illustrative embodiment;

FIG. 10 is an illustration of a flowchart of a process for generating an enhanced image in accordance with an illustrative embodiment;

FIG. 11 is an illustration of a flowchart of a process for modifying a number of enhanced elements in accordance with an illustrative embodiment;

FIG. 12 is an illustration of a flowchart of a process for generating a change to a design of a vehicle in accordance with an illustrative embodiment;

FIG. 13 is an illustration of a block diagram of a data processing system in accordance with an illustrative embodiment;

FIG. 14 is an illustration of a block diagram of an aircraft manufacturing and service method in accordance with an illustrative embodiment; and

FIG. 15 is an illustration of a block diagram of an aircraft in which an illustrative embodiment may be implemented.

### DETAILED DESCRIPTION

The illustrative embodiments recognize and take into account one or more different considerations as described herein. For example, collaboration between design engineers and three-dimensional artists is time consuming because of a need to balance technical accuracy with visual appeal and take into account customer preferences. Design Engineers interpret configuration files to extract relevant structural and system data. Three-dimensional artists use this data in developing detailed models and photorealistic renderings of the cabin interiors. This process involves multiple iterative cycles where customer feedback leads to design revisions, requiring adjustments to both technical components and visual elements. Each iteration adds to the workload. For example, even a minor change based on requests or ideas from a customer can affect the design in which updates, re-rendering, and technical validation are performed to meet customer expectations. Further, in some cases, third party design companies are involved increasing the complexity in coordination and time.

Thus, the illustrative examples provide a method, apparatus, system, and computer program product for generating aircraft interior designs. In the illustrative examples, a machine learning model such as a generative artificial intelligence model can be used in the design process. This model enables creating visualizations of interior details much faster than the current process. For example, the manner in which the generative artificial intelligence model are used in the illustrative examples provide a much quicker rendering of interior details such as seat colors, material changes, and placements compared to current techniques. Currently, design engineers work in coordination with three-dimensional design artists to create models and make changes using a computer-aided design system.

Furthermore, simulation of the construction of the aircraft interior can also be performed. The simulation can determine whether conflicts may occur between the design and the structure and systems in the aircraft. As a result, this type of simulation can reduce the amount of time needed to handle changes that may arise during program development thereby reducing the overall cost.

In one illustrative example, an interior design system comprises a computer system; a generative artificial intelligence model system in the computer system; and a design generator in the computer system. The design generator is configured to identify a reference image of an interior design of an interior of a vehicle and identify engineering data for the interior design and receive an element selection of a number of elements in the reference image of the interior design for modification. The design generator is configured to generate an enhanced image of the interior design using the number of elements in the reference image, the element selection, and the machine learning model system. The number of elements in the enhanced image are a number of enhanced elements. An element modification for modifying the number of enhanced elements in the enhanced image is received. The design generator is configured to modify the number of enhanced elements using the element modification that takes into account the engineering data and using the machine learning model system to form a customized image of the interior design with a number of modified elements in place of the number of enhanced elements. The design generator is configured to display the customized image on a display system.

In the different illustrative examples, the generation of the customized image with modifications to selected elements in the image for the design is based on input selecting the elements and identifying the modification. Further, these modifications take into account engineering data that provides information with respect to the elements. This information can also include what changes can be made to the elements. As a result, the changes made based on the modifications identified are realistic changes to the design that can be used in manufacturing or reconfiguring a platform such as an aircraft.

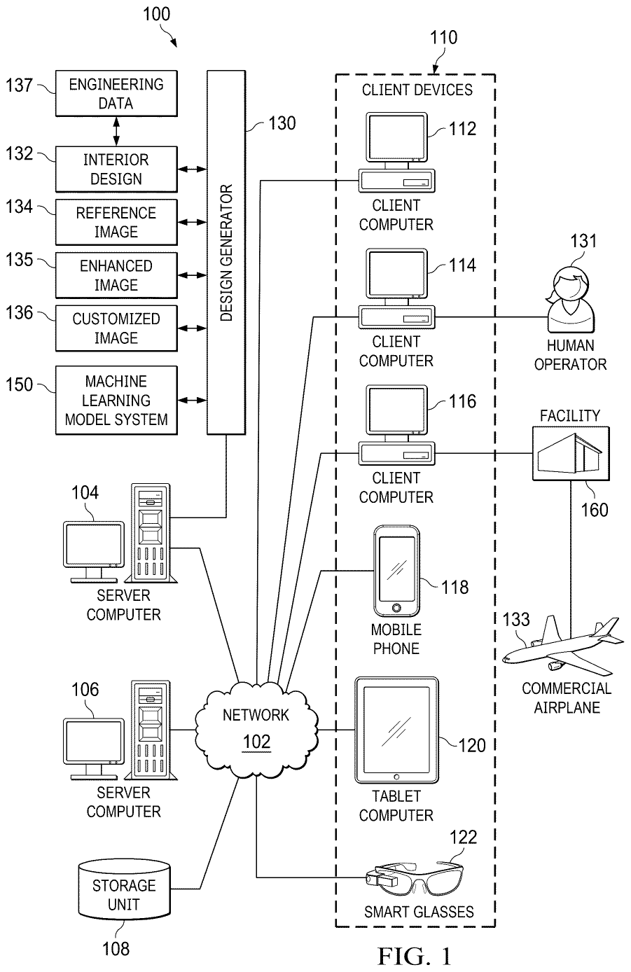

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. Client devices 110 can be, for example, computers, workstations, network computers, vehicles, machinery, appliances, or other devices that can process data. As depicted, client devices 110 include client computer 112, client computer 114, client computer 116, mobile phone 118, tablet computer 120, and smart glasses 122. Client devices 110 can be, for example, computers, workstations, or network computers. In the depicted example, server computer 104 provides information, such as boot files, operating system images, and applications to client devices 110.

In the depicted example, server computer 104 provides information, such as boot files, operating system images, and applications to client devices 110. Further, in this illustrative example, server computer 104, server computer 106, storage unit 108, and client devices 110 are network devices that connect to network 102 in which network 102 is the communications media for these network devices. Some or all of client devices 110 may form an Internet of Things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program instructions located in network data processing system 100 can be stored on a computer-recordable storage medium and downloaded to a data processing system or other device for use. For example, program instructions can be stored on a computer-recordable storage medium on server computer 104 and downloaded to client devices 110 over network 102 for use on client devices 110.

In this illustrative example, design generator 130 is located in server computer 104. This component can operate to at least one of generate or modify interior designs for aircraft.

Further, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

As depicted, human operator 131 can operate client computer 112 and interact with design generator 130 to make changes to interior design 132 for commercial airplane 133. In this example, design generator 130 can identify reference image 134 for interior design 132 for commercial airplane 133. Interior design 132 can be a model such as a computer-aided design model for the aircraft cabin in commercial airplane 133. The identification of reference image 134 can be made from a database of images in a computer-aided design model for the passenger cabin. Design generator 130 can display reference image 134 on client computer 114 to human operator 131.

This reference image can be for a portion of the interior design such as a portion of a passenger area in the aircraft cabin. In another example, reference image 134 can be for different portions of the design, such as a galley in the aircraft cabin.

Human operator 131 can select a portion of interior design 132 from the reference image through input such as text, voice, or drawing a bounding box around that portion of the design. For example, the portion can be an overhead bin within the aircraft cabin of commercial airplane 133.

With this example, design generator 130 generates enhanced image 135. This enhanced image can also be displayed to human operator 131 at client computer 114. This enhanced image has a number of enhanced elements based on the portion of the aircraft cabin selected for modification. In this example, the number of enhanced elements can be bins in the aircraft cabin. The enhancement can be a graphical indicator that draws attention to the number of enhanced elements, such as highlighting, color, or other graphical indicators that draw attention to the bins.

As used herein, “a number of” when used with reference to items, means one or more items. For example, “a number of enhanced elements” is one or more enhanced elements.

In this illustrative example, human operator 131 can create an element modification. In this illustrative example, human operator 131 can be a reviewer for a customer, a design engineer, or other person. The element modification can also be based on input from human operator 131. This input can be text or voice providing an explanation of the elements modification.

Additionally, the element modification directed by input from human operator 131 is also made taking into account engineering data 137 for interior design 132. This engineering data provides tolerances for interior design 132. Tolerances can be constraints for a value or ranges of values for modifications that are generated by human operators. For example, in modifying bins in interior design 132, the maximum size for these bins may be defined by tolerances in engineering data 137. Thus, modifications made by human operator 131 are realistic changes that can actually be implemented in commercial airplane 133.

In response, design generator 130 modifies the elements generated to form customized image 136 that can be displayed to human operator 131 at client computer 114. In response to viewing customized image 136, human operator 131 can approve interior design 132, make additional modifications to interior design 132 or perform other actions.

Additionally, the modifications to customized image 136 are made to interior design 132. For example, if interior design 132 is a computer-aided design model, these modifications to customized image 136 are made to the corresponding element or elements in the computer-aided design model.

These modifications may be made to interior design 132 in response to approvals of the modifications by human operator 131. These updates to interior design 132 can be validated by design engineers before being implemented for commercial airplane 133. In other examples, these modifications to interior design 132 can be made in response to generated customized image 136.

In this example, interior design 132 with modifications can be sent to client computer 116 at facility 160 for use in at least one of manufacturing, reconfiguration, or updates to commercial airplane 133 at facility 160. Facility 160 can be, for example, a manufacturing plant, a maintenance facility, a hanger, or other suitable location for manufacturing or performing modifications to commercial airplane 133. As a result, modifications can be made to interior design 132 by human operator 131 taking into account engineering data 137.

In these illustrative examples, image generation and modifications of interior designs can be made using machine learning model system 150.

In the depicted example, network data processing system 100 is the Internet with network 102 representing a worldwide collection of networks and gateways that use the Transmission Control Protocol/Internet Protocol (TCP/IP) suite of protocols or other networking protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As another example, design generator 130 can be located in client computer 112. In yet another illustrative example, design generator 130 can be distributed between server computer 104 and different client devices in client devices 110. For example, processing can be performed at server computer 104 and graphical user interfaces can be located at client devices 110.

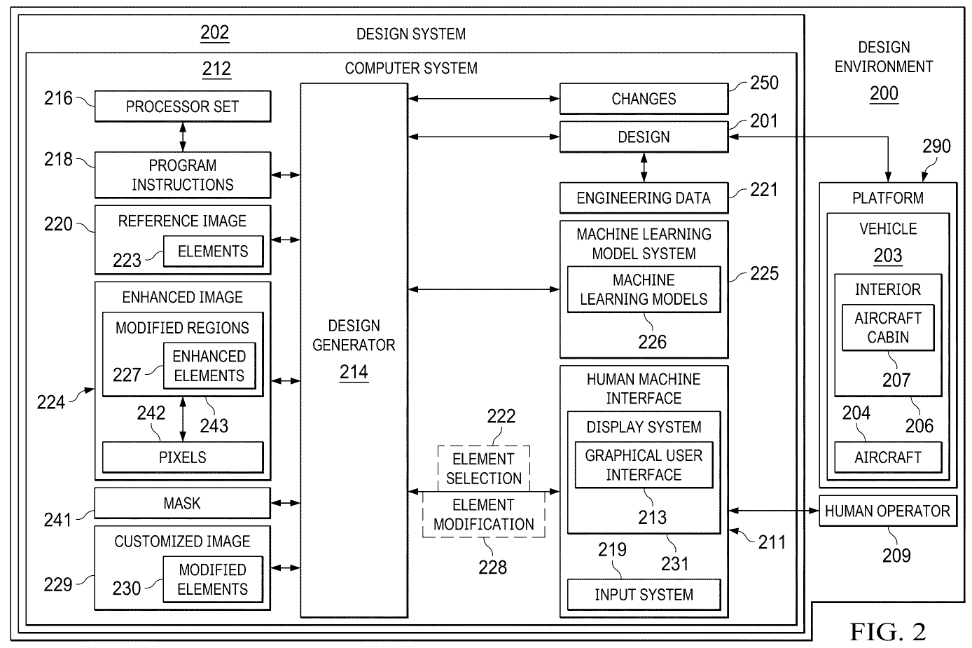

With reference now to FIG. 2, an illustration of a block diagram of a design environment is depicted in accordance with an illustrative embodiment. In this illustrative example, design system 202 in design environment 200 includes components that can be implemented in hardware such as the hardware shown in network data processing system 100 in FIG. 1. This interior design system operates to at least one of create or modify design 201 for platform 290. For example, design 201 can be for interior 206 of platform 290 in the form of vehicle 203.

Design 201 is a model of interior 206 in electronic form. This model can be, for example, a computer-aided design model, a point cloud model, a finite element analysis model, a two dimensional model, or other suitable model.

Interior design 132 can be associated with engineering data 221. This engineering data provides tolerances for design 201. In this example, engineering data 221 can include at least one of a number of tolerances for at least one of a physics based parameter, a volume, a material, a dimension, a density, an elasticity, a rigidness, a surface texture, a temperature based material behavior, a size, a location, an orientation, a weight, or other types of engineering data.

The tolerances in engineering data 221 can be constraints for one or more values or a range or ranges of values for modifications that can be made to design 201. In addition to tolerances, engineering data 221 can also include other information such as descriptions, vendor identifications, and other information regarding various elements in design 201.

For example, dimensions for overhead bins can have ranges of values for width, length, and other dimensions based on the particular aircraft in which the overhead bins are located. In some cases, the dimension can be a particular value rather than a range with respect to the tolerances for the overhead bins.

As another example, temperature based material behavior can be a color change based on temperature and can be imputed as a variable, this material can be used by design generator 214 to provide visualizations based on different environment temperatures.

Vehicle 203 can take a number of forms. For example, vehicle 203 can be selected from a group comprising aircraft 204, a commercial airplane, a cargo airplane, a rotorcraft, a tilt-rotor aircraft, a tilt wing aircraft, a vertical takeoff and landing aircraft, an unmanned aerial vehicle, an artificial intelligence controlled vehicle, an electric vertical takeoff and landing vehicle, a personal air vehicle, a surface ship, a cruise ship, a tank, a personnel carrier, a train, a spacecraft, a crewed spacecraft, a space plane, a submarine, a bus, an automobile and other vehicles in which interiors are present.

Interior 206 can be any interior area within vehicle 203. For example, when vehicle 203 is aircraft 204, interior 206 can be aircraft cabin 207. Aircraft cabin 207 can be, for example, a passenger seating area, a flight attendant seating area, a crew rest area, a galley, a lavatory, or other areas. In still other illustrative examples, interior 206 can be the cockpit of aircraft 204.

In this illustrative example, design system 202 comprises computer system 212 and design generator 214. Design generator 214 is located in computer system 212.

Design generator 214 can be implemented in software, hardware, firmware or a combination thereof. When software is used, the operations performed by design generator 214 can be implemented in program instructions configured to run on hardware, such as a processor unit. When firmware is used, the operations performed by design generator 214 can be implemented in program instructions and data and stored in persistent memory to run on a processor unit. When hardware is employed, the hardware can include circuits that operate to perform the operations in design generator 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, human operator 209 can interact with design generator 214 through human machine interface 211 in computer system 212. In this illustrative example, human machine interface (HMI) 211 is an interface system that can be used by human operator 209 to interact with different components in computer system 212. As depicted, human machine interface 211 comprises display system 231 and input system 219.

Display system 231 is a physical hardware system and includes one or more display devices on which graphical user interface 213 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

Human operator 209 is a person that can interact with graphical user interface 213 through user input generated by input system 219 for design generator 214. Input system 219 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device.

In one illustrative example, design generator 214 performs a number of different operations to make changes to design 201 for interior 206 of vehicle 203. For example, design generator 214 identifies reference image 220 of design 201 of interior 206 of vehicle 203. When vehicle 203 is aircraft 204, interior 206 can be aircraft cabin 207 or some other interior portion of aircraft 204.

The identification of reference image 220 can be made from a database of images, design 201, or other source. For example, an image or interior 206 in design 201 can be selected from a database of images for use. In another example, reference image 220 can be generated from design 201 in the form of a computer-aided design model.

This reference image can be for a portion of the interior design such as a portion of a passenger area in interior 206 in aircraft 204. In another example, reference image 220 can be for different portions of the design such as a galley in aircraft cabin 207.

Design generator 214 identifies engineering data 221 for the interior design. Engineering data 221 can be located within design 201, referenced by design 201, or associated with design 201 in some other manner.

Further, design generator 214 receives an element selection 222 of a number of elements 223 in the reference image 220 of design 201 for modification.

The number of elements 223 can take a number of different forms. For example, when the vehicle is aircraft 204, the number of elements 223 can be selected from at least one of a passenger seat, an overhead bin, a number of aisles, a seat cushion, a door, a light, a lighting system, an inflight entertainment system, a number of rows of passenger seats, a seat formation, or other elements within interior 206 of aircraft 204.

In this example, element selection 222 can be received from human machine interface 211 based on input generated by human operator 209. In this illustrative example, element selection 222 can be selected from at least one of text, voice, a touch gesture, or other types of input generated by human operator 209 using input system 219. For example, human operator 209 may enter text using the keyboard. As another example, human operator 209 may speak to cause input system 219 to generate a voice that is element selection 222. In yet another illustrative example, human operator 209 can use a touch gesture on a touchscreen to generate element selection 222 such as a bounding box around the number of elements 223. This and other types of input can be generated by human operator 209.

In this illustrative example, design generator 214 generates enhanced image 224 of design 201 using the number of elements 223 in reference image 220, element selection 222, and machine learning model system 225. The number of elements 223 in enhanced image 224 are a number of enhanced elements 227. This enhanced image can also be referred to as a masked image.

In this example, machine learning model system 225 is a number of machine learning models 226. Different operations for design generator 214 can be performed using one or more of machine learning models 226. One operation can be performed by a single machine learning model while two or more operations can be performed by another machine learning model.

For example, design generator 214 can generate enhanced image 224 by performing operations using one or more of machine learning models 226 in machine learning model system 225. Design generator 214 uses machine learning model system 225 to identify the number of elements 223 in reference image 220 using element selection 222 and machine learning model system 225. Design generator 214 uses machine learning model system 225 to create mask 241 that identifies pixels 242 representing the number of elements 223 identified in reference image 220 using element selection 222.

Further, design generator 214 uses machine learning model system 225 to change pixels 242 representing the number of elements 223 to create a number of modified regions for the number of elements 223 to form enhanced image 224 with the number of enhanced elements 227. The number of enhanced elements 227 in number of modified regions 243 is visually distinguished from other elements outside of the number of modified regions 243 in enhanced image 224.

In this example. mask 241 is comprised of pixels that identify which pixels are part of the number of elements 223 in which pixels are not a part of the number of elements 223. Mask 241 can be generated using a computer vision algorithm or a machine learning model such as U-Net, Mark R-CNN, or a Zero Shot Segmentation model in machine learning model system 225.

Design generator 214 can perform an operation such as displaying enhanced image 224 with the number of enhanced elements 227 being graphically emphasized on the display system 231. In this illustrative example, enhanced elements 227 can be graphically enhanced using a number of different types of graphical indicators that draw attention to the number of enhanced elements 227. These enhanced elements can be identified using at least one of a color, a highlighting, a brightness, a boundary, a pattern change, an animation or other graphical indicator

Design generator 214 can receive element modification 228 for modifying the number of enhanced elements 227 in enhanced image 224. In this example, the selection can be made by human operator 209 using human machine interface 211. This input can take forms similar to those used to generate element selection 222.

Design generator 214 modifies the number of enhanced elements 227 using element modification 228 that takes into account engineering data 221 using machine learning model system 225 to form customized image 229 of design 201 with a number of modified elements 230 in place of the number of enhanced elements 227.

In modifying the number of enhanced elements 227, design generator 214 uses machine learning model system 225 to identify a set of changes 250 to the number of enhanced elements 227 using element modification 228 that takes into account engineering data 221. Design generator 214 uses machine learning model system 225 to perform a diffusion from noise to the customized image 229 using the set of changes 250 identified to generate customized image 229 with the set of changes 250 to the number of enhanced elements 227 to form the number of modified elements 230 in customized image 229.

As used herein, a “set of” when used with reference items means one or more items. For example, a set of changes 250 is one or more of changes 250.

In this example, the set of changes 250 to the set of enhanced elements 227 can take a number of different forms. For example, the set of changes to the number of elements is selected from at least one of a color, a material, a dimension, a shape, a position, a location, an orientation, a surface finish, or a coating.

For performing diffusion, machine learning model system 225 includes a number of machine learning models 226 in the form of diffusion models that can perform diffusion. A diffusion model generates images by iteratively transforming random noise into a coherent image through a denoising process. The model can also learn to reverse the diffusion process by adding Gaussian noise to an image in multiple steps until the image is comprised of noise. During training, the model learns to predict and remove this noise at each step, effectively recovering the original image from noisy versions. For image generation, the process is reversed in which the training starts from pure noise. The diffusion model applies the learned denoising steps iteratively, refining the noise into an image.

In these examples, dual diffusion can be used in which two diffusion models are simultaneously trained to learn to diffuse images from images to noise and noise to images and apply that for domain style adaptation.

The number of diffusion models can take a number of forms. For example, the number diffusion models can be selected from at least one of a Denoising Diffusion Probabilistic Model (DDPMs), a Score Based Generative Model (SDEs), a Forward Diffusion model, a Reverse Diffusion model, or other suitable model.

Further in this example, design generator 214 displays customized image 229 on display system 231. Further, human operator 209 can determine whether to accept the number of modified elements 230 shown in customized image 229. In response to accepting or approving these modifications, design generator 214 can propagate or make changes to design 201 to include modified elements 230 shown in customized image 229.

With the changes to design 201, a practical application of the results created by design generator 214 includes manufacturing a new aircraft using design 201 for customized image 229. As another example, a practical application can involve reconfiguring an existing aircraft using design 201 for customized image 229. In these examples, design 201 for customized image 229 means that design 201 includes a number of modified elements 230 shown in customized image 229. For example, if a modified element is to change the size of a display in a passenger cabin, design 201 is also changed to reflect the change in size. Thus, design 201 MD modified to accurately reflect the number modified elements and customized image 229.

In one illustrative example, one or more technical solutions are present that overcome a technical problem with revising designs such as those for passenger cabins and aircraft. As a result, one or more technical solutions may provide a technical effect enabling automatic generation of customized images that provide visualizations of the modifications. These modifications are technically accurate because they take into account engineering data for the design. As a result, approval of the modification in a customized image can be implemented for actual production.

In the illustrative example, the use of design generator 214 in computer system 212 integrates processes into a practical application for a method for generating design modifications that can be used to manufacture or reconfigure platforms such as aircraft. For example, design generator 214 in computer system 212 provides a practical application using a change generated for interior design of a vehicle to manufacture the vehicle using the interior design or to reconfigure the vehicle using the interior design.

In one illustrative example, a method, apparatus, system, computer program product can generate a change to the design of an aircraft cabin. This change can be used in manufacturing the aircraft cabin for an aircraft. Further, this change in the design can also be used to perform reconfiguration, upgrade, or other maintenance to existing aircraft. The modifications can be made to other vehicles in addition to aircraft 204. Thus, the illustrative examples can be used to perform operations to manufacture or reconfigure the interior of a vehicle.

The illustration of design environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

As another example, when vehicle 203 takes the form of a surface ship such as a cruise ship, interior 206 can be any interior portion of the cruise ship. For example, the interior can be a dining area, a passenger room, a workout room, a kitchen, a hallway, a theater, or other interior portion of the cruise ship. In yet another illustrative example, design 201 can be for other portions of vehicle 203 in addition to interior 206. For example, design 201 can be for physical structures in addition to those in interior 206 of vehicle 203 such as an exterior surface, a system, a structure within a wall, a wiring harness location within a fuselage, a control surface, and designs for other structures. Thus, design 201 can be of an interior, a physical structure, an exterior, or other designs for platform 290.

In another illustrative example, element modification 228 can be made by another human operator in addition to human operator 209 operating a different human machine interface from human machine interface 211.

In yet other illustrative examples, platform 290 can take other forms in addition to vehicle 203. For example, in addition to vehicle 203, platform 290 can also be a mobile platform, a stationary platform, a land-based structure, an aquatic-based structure, and a space-based structure, a power plant, a bridge, a dam, a house, a manufacturing facility, and a building.

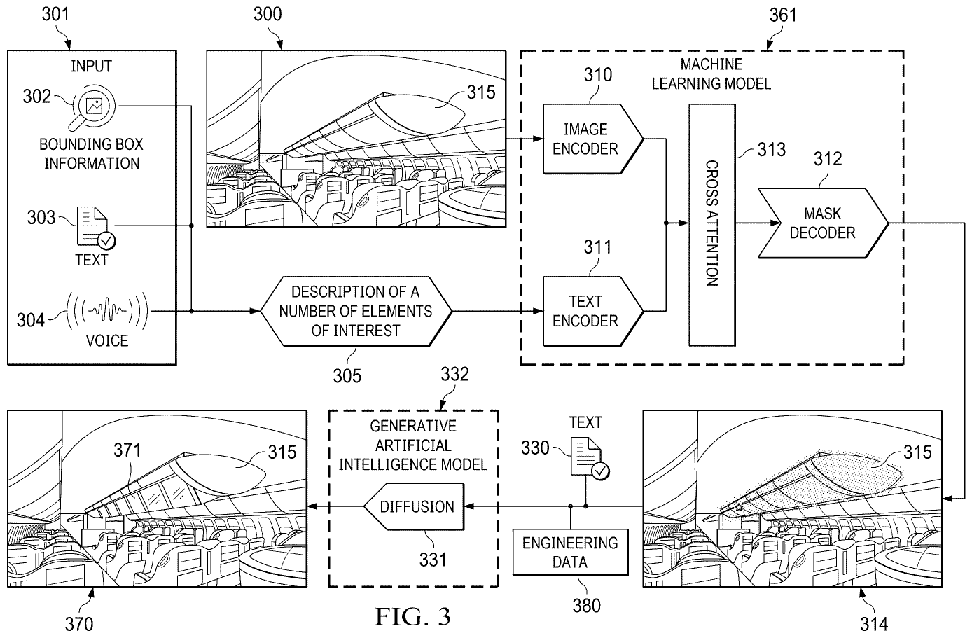

With reference next to FIG. 3, an illustration of a process flow diagram for changing visualization of an interior design is depicted in accordance with an illustrative embodiment. The process flow in this illustrative example can be implemented in design system 202 using design generator 214 in FIG. 2.

In this example, reference image 300 is an image for the interior design of a passenger cabin that is to be changed. Reference image 300 can be located in an image database for the interior design, generated from the interior design, or from some other source. For example, the interior design can be a computer-aided design (CAD) model of the interior of an aircraft. An image can be generated from this computer-aided design model.

This image can be viewed by a human operator on a display system. The human operator can then generate input 301 to specify what parts of reference image 300 are to be changed. These parts can be a number of elements within reference image 300. This number of elements can be, for example, selected from a group comprising overhead bins, passenger seats, in-flight entertainment centers, an aisle, and other elements.

These number of elements in reference image 300 can be of the same type or different types. For example, the number of elements can include overhead bins and passenger seats while in other examples, the number of elements can be overhead bins. In yet another illustrative example, the number of elements can be just a single overhead bin in the overhead bins.

In this illustrative example, input 301 can be generated by a human operator through a human machine interface to select one or more elements to change in reference image 300. Input 301 can take a number of different forms. For example, input 301 can be at least one of bounding box information 302, text 303, or voice 304.

Bounding box information 302 can be generated in a number of different ways. For example, bounding box information 302 can be generated using a touch gesture to draw the bounding box around elements to be changed in reference image 300. For example, bounding box information 302 can be information about where the specific elements are located in reference image 300. This bounding box information can include a center of the bounding box and the width and height of the bounding box that surrounds one or more elements in reference image 300.

In this example, text 303 can be a textual description of elements to be changed in reference image 300. For example, text 303 describes the number of elements to be changed. For example, text 303 can be at least one of overhead bins, passenger seats, aisles, or some other text to identify elements for change.

Voice 304 is audio information describing the number of elements to be changed. Voice 304 can be the same description as text 303 but in an audio form.

These inputs form description of a number of elements of interest 305 that is used to identify those elements in reference image 300. Description of a number of elements of interest 305 can be an example of element selection 222 in FIG. 2. In this example, the elements of interest are overhead bins 315 in reference image 300.

In the illustrative example, reference image 300 and description of a number of elements of interest 305 are inputs into machine learning model 361. This machine learning model can be a fully generative artificial intelligence model. Image encoder 310 in machine learning model 361 receives reference image 300 and outputs a numerical representation of reference image 300 that can be used by a machine learning model. Text encoder 311 in machine learning model 361 receives description of a number of elements of interest 305 and outputs a numerical representation of this description that can be used by a machine learning model

Mask decoder 312 in machine learning model 361 receives description of a number of elements of interest 305 and outputs a numerical representation of this description by a machine learning model. The outputs of these two encoders are aligned in common latent space using cross attention 313 in machine learning model 361.

These outputs are received by mask decoder 312 in machine learning model 361. Mask decoder 312 identifies and highlights overhead bins 315 to generate enhanced image 314. This mechanism for identifying overhead bins 315 can be a segmentation mask, a bounding box prediction, or a heat map mechanism. Mask decoder 312 outputs enhanced image 314 in which overhead bins 315 in enhanced image 314 are highlighted or otherwise graphically identified.

Next, enhanced image 314 and text 330 are inputs for diffusion 331 in generative artificial intelligence model 332. In this example, diffusion 331 can include generating an image with noise from enhanced image 314 and forming the noise to generate customized image 370. In creating an image with noise, noise can be gradually added to enhanced image 314 over multiple steps, transforming this image into a noisy version. During training, generative artificial intelligence model 332 learns how data behaves as it becomes increasingly noisy.

In performing denoising, generative artificial intelligence model 332 is trained to reverse the noising process. In this example, diffusion 331 in generative artificial intelligence model 332 starts from a noisy input. Diffusion 331 iteratively removes the noise, reconstructing the data step by step to form an image. This denoising in diffusion 331 in generative artificial intelligence model 332 can be performed through successive steps using text 330 and engineering data 380 to generate customized image 370.

In this example, text 330 identifies an element modification for overhead bins 315. For example, text 330 can be “aircraft cabin with integrated large-screen” that is used to modify overhead bins 315 from enhanced image 314. In this example, diffusion 331 is performed using enhanced image 314 and text 330 to generate customized image 370 which now has integrated screens 371 in place of overheard bins 315.

Diffusion 331 performed on enhanced image 314 to generate customized image 370 with integrated screens 371 is performed subject to engineering data 380 which is also input into generative artificial intelligence model 332 to perform diffusion 331. Engineering data used to provide constraints for modifications to overhead bins 315. For example, engineering data 380 can define the maximum size for integrated screens 371.

In these examples, diffusion 331 for generative artificial intelligence model 332 can be implemented in a number of different types of models. For example, without limitation, generative artificial intelligence model 332 can be selected from a group comprising a diffusion model, a latent diffusion model, a DALL-E 2 model, a denoising diffusion probabilistic model, a style domain adaptation model, a style transfer model, a generative adversarial network, an auto-encoder, a Gaussian Splatting model, a NeRF model, or a trilinear point splatting model.

Further, generative artificial intelligence models can be fully generative artificial intelligence models. This type of artificial intelligence model can autonomously generate new data such as images without requiring detail input or conditions covering all aspects of the image generation. In these examples, the image generation can include modification of elements in a current image.

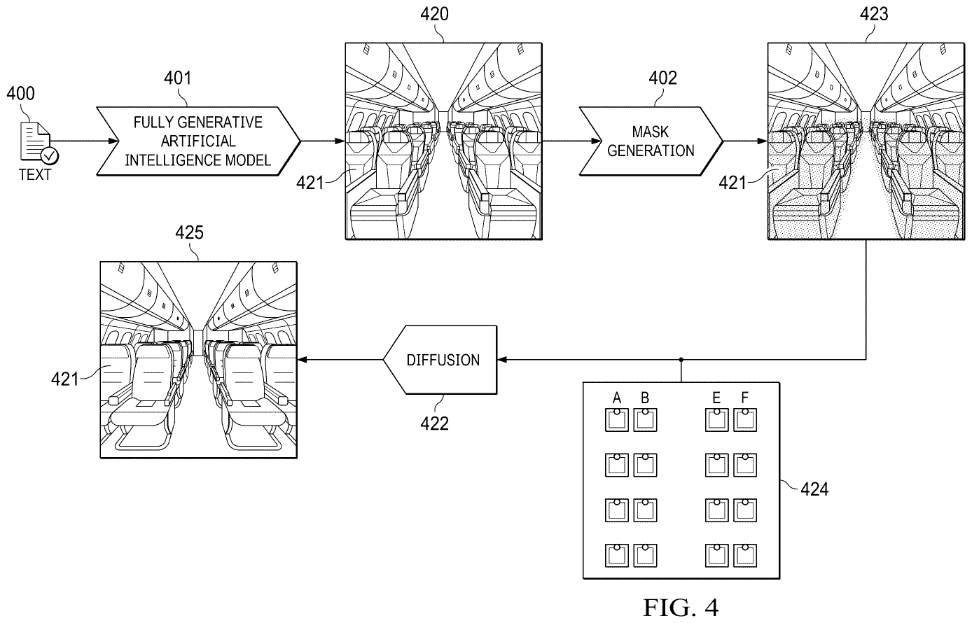

Turning now to FIG. 4, an illustration of a process flow diagram for changing visualization of an interior design is depicted in accordance with an illustrative embodiment. The process flow in this illustrative example can be implemented in design system 202 using design generator 214 in FIG. 2.

In this example, text 400 is an input into fully generative artificial intelligence model 401. In this example, this model generates an image of an interior design for modification. For example, fully generative artificial intelligence model 401 can generate reference image 300 in FIG. 3 for modification. This image can be generated using an interior design in the form of a computer-aided design. For example, the computer-aided design model is an aircraft. Text 400 is “modify passenger seats for aircraft order number xxx to have a carbon fiber appearance.” In this example, with text 400, fully generative artificial intelligence model 401 generates reference image 420 of passenger seats 421 using the computer-aided design model for the aircraft that is to be manufactured for aircraft order number xxx.

Mask generation 402 generates enhanced image 423 of passenger seats 421 in which these passenger seats are highlighted. In this example, mass generation can be formed using machine learning model 361 in FIG. 3. In this example, text 400 also includes the element selection selecting the passenger seats for modification.

Next, diffusion 422 is performed to modify the passenger seats from enhanced image 423. In this example, the modification is also identified from text 400. This modification is subject to engineering data in the form of two-dimensional layout 424. In this example, enhanced image 423, two-dimensional layout 424, and text 400 are inputs to diffusion 422.

Diffusion 422 generates customized image 425 with passenger seats 421 that have a carbon fiber appearance. Two-dimensional layout 424 is used by the denoising process in diffusion 422 to ensure that passenger seats 421 in customized image 425 follow the layout of passenger seats in two-dimensional layout 424.

Thus, in this example, text 400 is a single input that selects the reference image, identifies elements to be modified, and identifies the modification to be made.

The illustration of the process flows in FIGS. 3-4 are example implementations of process flows that can be implemented by design generator 130 in FIG. 1 and design generator 214 in FIG. 2 to modify interior designs and are not meant to limit the manner in which other examples can be implemented. For example, in other illustrative examples, interiors of other types of vehicles other than aircraft can be modified.

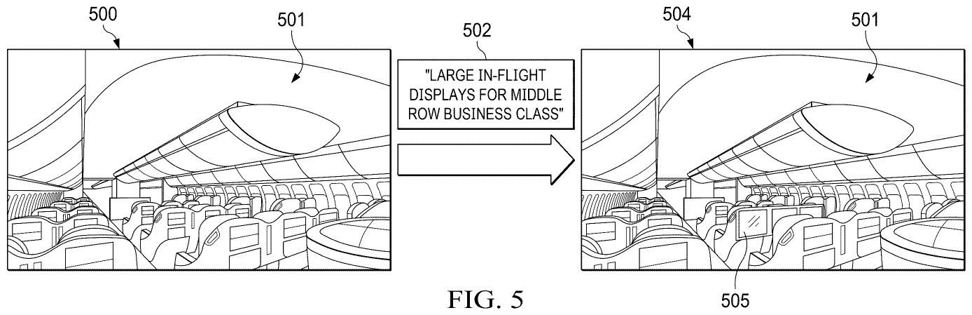

FIGS. 5-7 are illustrations of process flows to generate customized images that can be generated for vehicles and other platform designs. The modifications shown in these images can be made to interior designs for aircraft in response to the generation of the customized image and approval of the modification in the customized image.

With reference to FIG. 5, an illustration of a process flow for customizing an interior of a passenger cabin is depicted in accordance with an illustrative embodiment. The process flow in this example can be implemented using design system 202 in FIG. 2.

In this example, reference image 500 is a reference image of passenger cabin 501. In this example, input 502 is both an element selection that selects elements for modification and an element modification that describes the design for passenger cabin 501.

In this example, input 502 is “large in-flight displays for middle row business class” and can take a number of different forms. For example, input 502 can be at least one of text or voice in this example. This input both selects the elements for modification as well as the modification to be made.

Customized image 504 of passenger cabin 501 is generated. In this example, large in-flight displays 505 have been added to passenger cabin 501 in customized image 504.

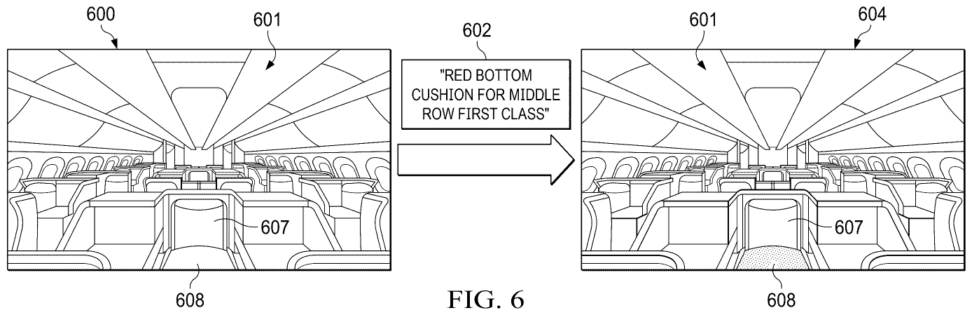

Turning to FIG. 6, an illustration of a process flow for customizing an interior of a passenger cabin is depicted in accordance with an illustrative embodiment. The process flow in this example can be implemented using design system 202 in FIG. 2.

In this example, reference image 600 is a reference image of passenger cabin 601. In this example, input 602 is both an element selection that selects elements for modification and an element modification that describes the design for passenger cabin 601.

In this example, input 602 is both an element selection that selects an element for modification and an element modification that describes the change to the design for passenger cabin 601. As depicted, input 602 is “red bottom cushion for middle row first class” and this input can take a number of different forms. For example, input 602 can be at least one of text or voice in this example. The elements selected for the change by input 602 is bottom cushion 608 for passenger seat 607.

Customized image 604 of passenger cabin 601 is generated in response to input 602. In this example, red bottom cushion 605 has been added to passenger seat 607 in passenger cabin 601 in customized image 604.

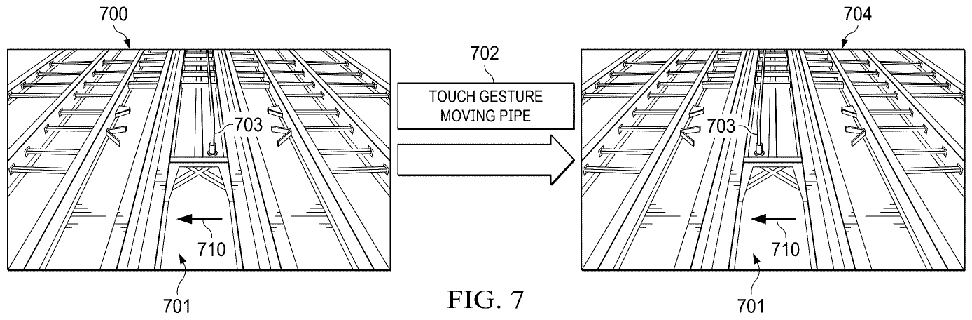

Next in FIG. 7, an illustration of a process flow for customizing an aircraft structure is depicted in accordance with an illustrative embodiment. The process flow in this example can be implemented using design system 202 in FIG. 2.

As depicted, reference image 700 is an image of aircraft structure 701. In this example, input 702 selects an element for modification and the modification to the design for aircraft structure 701. In this example, input 702 is “touch gesture moving pipe” in the direction of arrow 710.

In response to input 702, customized image 704 is generated for aircraft structure 701. As depicted in customized image 704, pipe 703 has been moved in the direction of arrow 710 in customized image 704. In this manner, a design engineer can see how aircraft structure 701 will look with the movement of pipe 703.

The illustration of the process flows in FIGS. 6-7, provided as examples, are not meant to limit the manner in which other illustrative examples can be implemented. For example, these process flows can be applied to interiors for other vehicles such as a train or bus. Additionally, the process flows can be applied to different platforms in addition to vehicles such as a bridge, a manufacturing facility, an auditorium, or other platform.

The different customized images generated in FIGS. 5-7 have modifications from reference images that can be applied to the design for a particular platform. The application of these modifications can be made in response to generating the customized image or in response to an approval of the modification in the customized image. In this manner, a design such as a computer-aided design file can be modified using this process flow. Further, the modified design can then be implemented in manufacturing or reconfiguring an existing platform.

These different examples generate customized images based on the design and take into account engineering data. For example, although not shown, the modifications made for the inputs are made taking into account the engineering data for the design.

Engineering data can provide constraints on modifications that are made. For example, the color of the bottom seat may be subject to materials or allowed colors for a particular customer. As another example, the size of in-flight displays can be limited by the amount of space specified in the design specifications of a particular class in a passenger cabin.

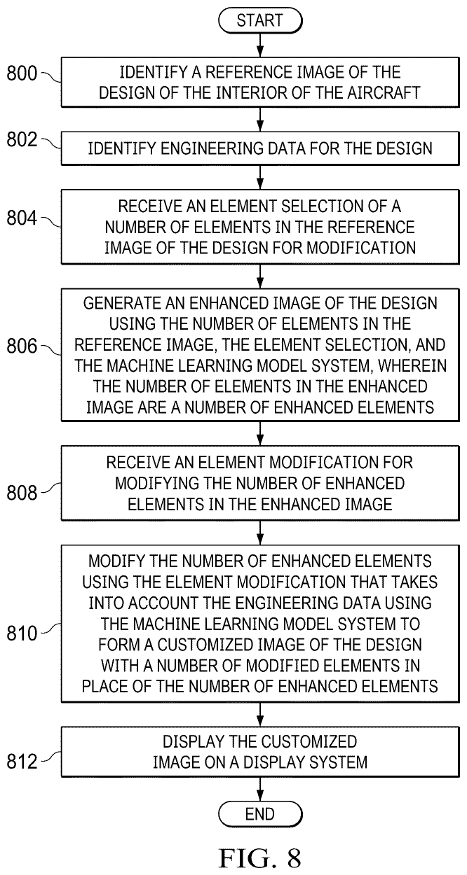

With reference next to FIG. 8, an illustration of a flowchart of a process for generating a change to a design of an interior of an aircraft is depicted in accordance with an illustrative embodiment. The process in FIG. 8 can be implemented in hardware, software, or both. When implemented in software, the process can take the form of program instructions that are run by one of more processor units located in one or more hardware devices in one or more computer systems. For example, the process can be implemented in design generator 130 in server computer 104 in FIG. 1 and design generator 214 in computer system 212 in FIG. 2.

The process identifies a reference image of the design of the interior of the aircraft (operation 800). The process identifies engineering data for the design (operation 802).

The process receives an element selection of a number of elements in the reference image of the design for modification (operation 804). The process generates an enhanced image of the design using the number of elements in the reference image, the element selection, and the machine learning model system, wherein the number of elements in the enhanced image are a number of enhanced elements(operation 806).

The process receives an element modification for modifying the number of enhanced elements in the enhanced image (operation 808). The process modifies the number of enhanced elements using the element modification that takes into account the engineering data using the machine learning model system to form a customized image of the design with a number of modified elements in place of the number of enhanced elements (operation 810).

The process displays the customized image on a display system (operation 812). The process terminates thereafter.

In this flowchart, the machine learning model system comprises a first generative artificial intelligence model trained to generate the enhanced image. This machine learning model system also comprises a second generative artificial intelligence model trained to generate the customized image. The second generative artificial intelligence model can be selected from a group comprising a diffusion model, a latent diffusion model, a DALL-E 2 model, a denoising diffusion probabilistic model, and other suitable types of machine learning models that can perform diffusion.

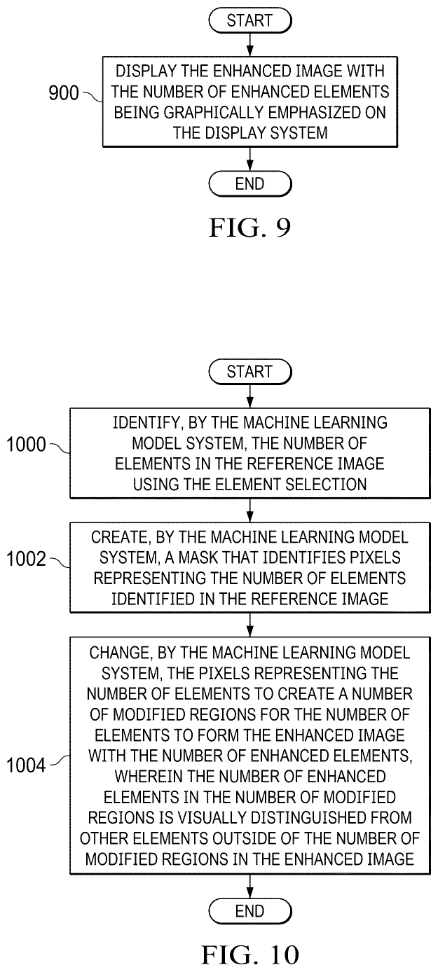

Next in FIG. 9, an illustration of a flowchart of a process for displaying an enhanced image is depicted in accordance with an illustrative embodiment. The operation in this flowchart is an example of an additional operation that can be performed with the operations in FIG. 8.

The process displays the enhanced image with the number of enhanced elements being graphically emphasized on the display system (operation 900). The process terminates thereafter.

With reference now to FIG. 10, an illustration of a flowchart of a process for generating an enhanced image is depicted in accordance with an illustrative embodiment. The process in this flowchart is an example of an implementation for operation 806 in

FIG. 8. In this flowchart, the different operations can be performed using machine learning model system 150 in FIG. 1 and machine learning model system 225 in FIG. 2.

The process begins by identifying, by the machine learning model system, the number of elements in the reference image using the element selection (operation 1000). The process creates, by the machine learning model system, a mask that identifies pixels representing the number of elements identified in the reference image (operation 1002).

The process changes, by the machine learning model system, the pixels representing the number of elements to create a number of modified regions for the number of elements to form the enhanced image with the number of enhanced elements, wherein the number of enhanced elements in the number of modified regions is visually distinguished from other elements outside of the number of modified regions in the enhanced image (operation 1004). The process terminates thereafter.

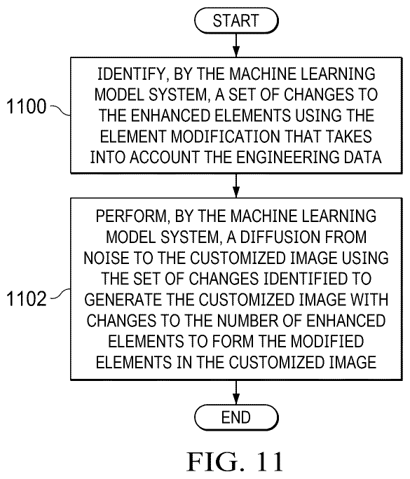

Turning to FIG. 11, an illustration of a flowchart of a process for modifying a number of enhanced elements is depicted in accordance with an illustrative embodiment. The operations in this flowchart are an example of an implementation for operation 810 in FIG. 8. These operations can be implemented using machine learning model system 150 in FIG. 1 and machine learning model system 225 in FIG. 2.

The process identifies, by the machine learning model system, a set of changes to the enhanced elements using the element modification that takes into account the engineering data (operation 1100). The process performs, by the machine learning model system, a diffusion from noise to the customized image using the set of changes identified to generate the customized image with changes to the number of enhanced elements to form the modified elements in the customized image (operation 1102). The process terminates thereafter.

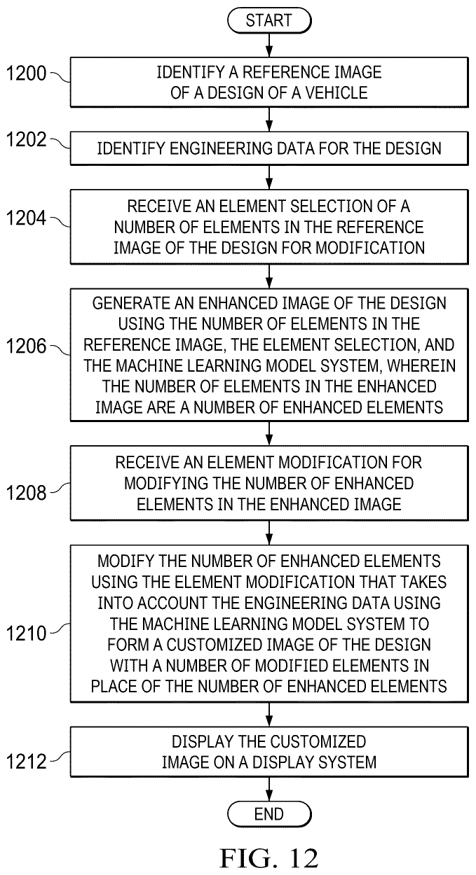

Turning next to FIG. 12, an illustration of a flowchart of a process for generating a change to a design of a vehicle is depicted in accordance with an illustrative embodiment. The process in FIG. 12 can be implemented in hardware, software, or both. When implemented in software, the process can take the form of program instructions that are run by one of more processor units located in one or more hardware devices in one or more computer systems. For example, the process can be implemented in design generator 130 in server computer 104 in FIG. 1 and design generator 214 in computer system 212 in FIG. 2.

The process begins by identifying a reference image of a design of a vehicle (operation 1200). The process identifies engineering data for the design (operation 1202).

The process receives an element selection of a number of elements in the reference image of the design for modification (operation 1204). The process generates an enhanced image of the design using the number of elements in the reference image, the element selection, and the machine learning model system, wherein the number of elements in the enhanced image are a number of enhanced elements (operation 1206).

The process receives an element modification for modifying the number of enhanced elements in the enhanced image (operation 1208). The process modifies the number of enhanced elements using the element modification that takes into account the engineering data using the machine learning model system to form a customized image of the design with a number of modified elements in place of the number of enhanced elements (operation 1210).

The process displays the customized image on a display system (operation 1212). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

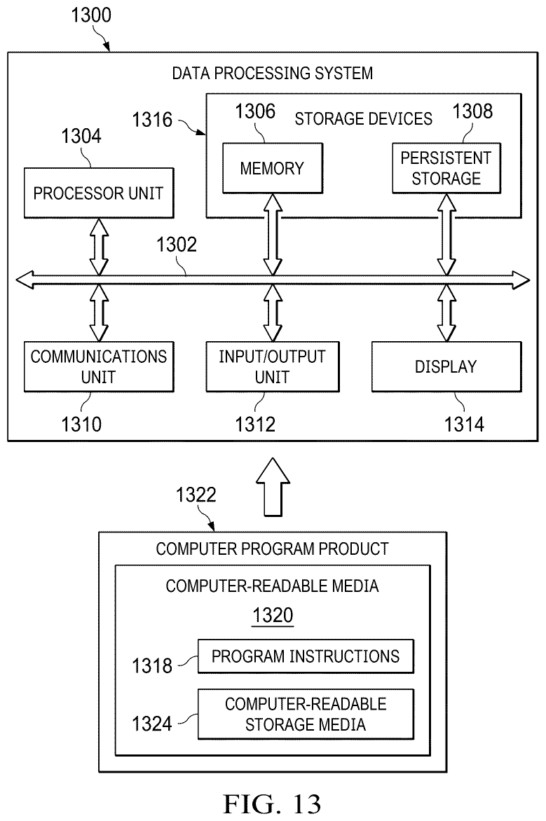

Turning now to FIG. 13, an illustration of a block diagram of a data processing system is depicted in accordance with an illustrative embodiment. Data processing system 1300 can be used to implement server computer 104, server computer 106, client devices 110, in FIG. 1. Data processing system 1300 can also be used to implement computer system 212 in FIG. 2. In this illustrative example, data processing system 1300 includes communications framework 1302, which provides communications between processor unit 1304, memory 1306, persistent storage 1308, communications unit 1310, input/output (I/O) unit 1312, and display 1314. In this example, communications framework 1302 takes the form of a bus system.

Processor unit 1304 serves to execute instructions for software that can be loaded into memory 1306. Processor unit 1304 includes one or more processors. For example, processor unit 1304 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1304 can be implemented using one or more heterogeneous processor systems in which a main processor is present with secondary processors on a single chip. As another illustrative example, processor unit 1304 can be a symmetric multi-processor system containing multiple processors of the same type on a single chip.

Memory 1306 and persistent storage 1308 are examples of storage devices 1316. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1316 may also be referred to as computer-readable storage devices in these illustrative examples. Memory 1306, in these examples, can be, for example, a random-access memory or any other suitable volatile or non-volatile storage device. Persistent storage 1308 may take various forms, depending on the particular implementation.

For example, persistent storage 1308 may contain one or more components or devices. For example, persistent storage 1308 can be a hard drive, a solid-state drive (SSD), a flash memory, a rewritable optical disk, a rewritable magnetic tape, or some combination of the above. The media used by persistent storage 1308 also can be removable. For example, a removable hard drive can be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that can be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating system, applications, or programs can be located in storage devices 1316, which are in communication with processor unit 1304 through communications framework 1302. The processes of the different embodiments can be performed by processor unit 1304 using computer-implemented instructions, which may be located in a memory, such as memory 1306.

These instructions are referred to as program instructions, computer usable program instructions, or computer-readable program instructions that can be read and executed by a processor in processor unit 1304. The program instructions in the different embodiments can be embodied on different physical or computer-readable storage media, such as memory 1306 or persistent storage 1308.

Program instructions 1318 are located in a functional form on computer-readable media 1320 that is selectively removable and can be loaded onto or transferred to data processing system 1300 for execution by processor unit 1304. Program instructions 1318 and computer-readable media 1320 form computer program product 1322 in these illustrative examples. In the illustrative example, computer-readable media 1320 is computer-readable storage media 1324.

Computer-readable storage media 1324 is a physical or tangible storage device used to store program instructions 1318 rather than a medium that propagates or transmits program instructions 1318. Computer-readable storage media 1324 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer-readable storage media 1324, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1318 can be transferred to data processing system 1300 using a computer-readable signal media. The computer-readable signal media are signals and can be, for example, a propagated data signal containing program instructions 1318. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1320” can be singular or plural. For example, program instructions 1318 can be located in computer-readable media 1320 in the form of a single storage device or system. In another example, program instructions 1318 can be located in computer-readable media 1320 that is distributed in multiple data processing systems. In other words, some instructions in program instructions 1318 can be located in one data processing system while other instructions in program instructions 1318 can be located in one data processing system. For example, a portion of program instructions 1318 can be located in computer-readable media 1320 in a server computer while another portion of program instructions 1318 can be located in computer-readable media 1320 located in a set of client computers.

The different components illustrated for data processing system 1300 are not meant to provide architectural limitations to the manner in which different embodiments can be implemented. In some illustrative examples, one or more of the components may be incorporated in or otherwise form a portion of, another component. For example, memory 1306, or portions thereof, may be incorporated in processor unit 1304 in some illustrative examples. The different illustrative embodiments can be implemented in a data processing system including components in addition to or in place of those illustrated for data processing system 1300. Other components shown in FIG. 13 can be varied from the illustrative examples shown. The different embodiments can be implemented using any hardware device or system capable of running program instructions 1318.

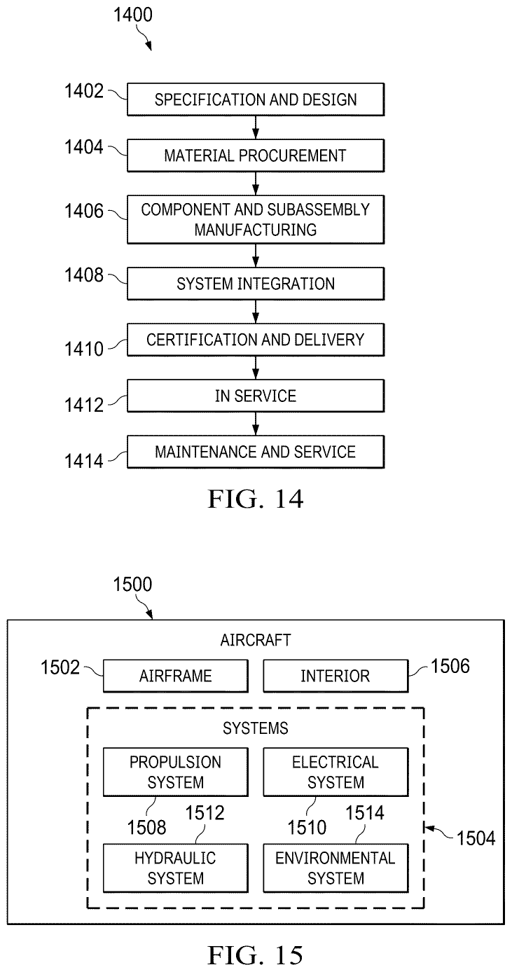

Illustrative embodiments of the disclosure may be described in the context of aircraft manufacturing and service method 1400 as shown in FIG. 14 and aircraft 1500 as shown in FIG. 15. Turning first to FIG. 14, an illustration of a block diagram of an aircraft manufacturing and service method is depicted in accordance with an illustrative embodiment. During pre-production, aircraft manufacturing and service method 1400 may include specification and design 1402 of aircraft 1500 in FIG. 15 and material procurement 1404.

During production, component and subassembly manufacturing 1406 and system integration 1408 of aircraft 1500 in FIG. 15 takes place. Thereafter, aircraft 1500 in FIG. 15 can go through certification and delivery 1410 in order to be placed in service 1412. While in service 1412 by a customer, aircraft 1500 in FIG. 15 is scheduled for routine maintenance and service 1414, which may include modification, reconfiguration, refurbishment, and other maintenance or service.

Each of the processes of aircraft manufacturing and service method 1400 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 15, an illustration of a block diagram of an aircraft is depicted in which an illustrative embodiment may be implemented. In this example, aircraft 1500 is produced by aircraft manufacturing and service method 1400 in FIG. 14 and may include airframe 1502 with plurality of systems 1504 and interior 1506. Examples of systems 1504 include one or more of propulsion system 1508, electrical system 1510, hydraulic system 1512, and environmental system 1514. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1400 in FIG. 14.

In one illustrative example, components or subassemblies produced in component and subassembly manufacturing 1406 in FIG. 14 can be fabricated or manufactured in a manner similar to components or subassemblies produced while aircraft 1500 is in service 1412 in FIG. 14. As yet another example, one or more apparatus embodiments, method embodiments, or a combination thereof can be utilized during production stages, such as component and subassembly manufacturing 1406 and system integration 1408 in FIG. 14. One or more apparatus embodiments, method embodiments, or a combination thereof may be utilized while aircraft 1500 is in service 1412, during maintenance and service 1414 in FIG. 14, or both. The use of a number of the different illustrative embodiments may substantially expedite the assembly of aircraft 1500, reduce the cost of aircraft 1500, or both expedite the assembly of aircraft 1500 and reduce the cost of aircraft 1500.

The design generator in the different illustrative examples can be used in at least one of specification and design 1402 and maintenance and service 1414. During specification and design 1402, the design generator can be used to reduce the amount of time needed to make design changes or updates to aircraft 1500 that will be manufactured for a customer. Different changes to elements in the design of aircraft 1500 can be made in a manner that reduces or eliminates the need for design engineers and designers to make and verify that changes requested can be made. Further, design generator can be used to make changes to aircraft 1500 after it has been manufactured. These changes can be made for maintenance and service 1414 that includes include modification, reconfiguration, refurbishment, and other maintenance or service. For example, reconfiguration of passenger seats can be made more quickly. As another example, replacement seats of different designs including different colors, sizes, dimensions, and materials can be made.

Thus, illustrative examples provide a method, apparatus, system, and computer program product that enables modifying designs for interiors of aircraft presented to customers based on customer feedback. In these different illustrative examples, demand of time needed to collaborate between customers, design engineers, and three-dimensional artists to design and render interiors is produced using design systems such as design system 202 in FIG. 2.

In one illustrative example, an interior design system comprises a computer system; a generative artificial intelligence model system in the computer system; and a design generator in the computer system. The design generator is configured to identify a reference image of an interior design of an interior of a vehicle and identify engineering data for the interior design; and receive an element selection of a number of elements in the reference image of the interior design for modification. The design generator is configured to generate an enhanced image of the interior design using the number of elements in the reference image, the element selection, and the machine learning model system. The number of elements in the enhanced image are a number of enhanced elements. An element modification is received for modifying the number of enhanced elements in the enhanced image. The design generator is configured to modify the number of enhanced elements using the element modification that takes into account the engineering data using the machine learning model system to form a customized image of the interior design with a number of modified elements in place of the number of enhanced elements. The design generator is configured to display the customized image on a display system.

In the different illustrative examples, the generation of the customized image with modifications to selected elements in the image for the design is based on input selecting the elements and identifying the modification. Further, these modifications take into account engineering data that provides information with respect to the elements. This information can also include what changes can be made to the elements. As a result, the changes made based on the modifications identified are changes that can actually be made to the design because engineering data for the design is taken into account.

As a result, the number of iterations between customers, design engineers, three-dimensional artists, and other personnel can be reduced. A process flow implemented in the design system in the illustrative examples uses machine learning models in a manner that reduces the need for multiple iterations of a process involving design engineers, three-dimensional artists, and customers.

In one example, the design system in the different illustrative examples can be used the first pass of a design for an interior of aircraft such as a passenger cabin in aircraft is generated. The design system in these examples enable performing multiple iterations based on customer feedback while reducing the amount of time and cost needed for revising or changing the design.

Further, these modifications in the customized images can be implemented into the design such that at least one of manufacturing or reconfiguring platforms, such as aircraft or other vehicles, can be performed more efficiently.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A design system comprising:
a computer system;
a machine learning model system in the computer system; and
a design generator in the computer system, wherein the design generator is configured to perform operations comprising:
identifying a reference image of a design of an interior of an aircraft,
identifying engineering data for the design;
receiving an element selection of a number of elements in the reference image of the design for modification;
generating an enhanced image of the design using the number of elements in the reference image, the element selection, and the machine learning model system, wherein the number of elements in the enhanced image are a number of enhanced elements;
receiving an element modification for modifying the number of enhanced elements in the enhanced image;
modifying the number of enhanced elements using the element modification that takes into account the engineering data using the machine learning model system to form a customized image of the design with a number of modified elements in place of the number of enhanced elements; and
displaying the customized image on a display system.

2. The design system of claim 1, wherein the design generator is further configured to perform the operations comprising:
displaying the enhanced image with the number of enhanced elements being graphically emphasized on the display system.

3. The design system of claim 1, wherein the machine learning model system comprises a first generative artificial intelligence model trained to generate the enhanced image and a second generative artificial intelligence model trained to generate the customized image.

4. The design system of claim 3, wherein the second generative artificial intelligence model is selected from a group comprising a diffusion model, a latent diffusion model, a DALL-E 2 model, a denoising diffusion probabilistic model, a style domain adaptation model, a style transfer model, a generative adversarial network, an auto-encoder, a Gaussian Splatting model, a NeRF model, or a trilinear point splatting model.

5. The design system of claim 1, wherein in generating the enhanced image, the design generator is configured to perform the operations comprising:
identifying, by the machine learning model system, the number of elements in the reference image using the element selection;
creating, by the machine learning model system, a mask that identifies pixels representing the number of elements identified in the reference image; and
changing, by the machine learning model system, the pixels representing the number of elements to create a number of modified regions for the number of elements to form the enhanced image with the number of enhanced elements, wherein the number of enhanced elements in the number of modified regions is visually distinguished from other elements outside of the number of modified regions in the enhanced image.

6. The design system of claim 1, wherein in modifying the number of enhanced elements, the design generator is configured to perform the operations comprising:
identifying, by the machine learning model system, a set of changes to the enhanced elements using the element modification that takes into account the engineering data; and
performing, by the machine learning model system, a diffusion from noise to the customized image using the set of changes identified to generate the customized image with changes to the number of enhanced elements to form the modified elements in the customized image.

7. The design system of claim 6, wherein the set of changes to the number of enhanced elements is selected from at least one of a color, a material, a dimension, a shape, a position, a location, an orientation, a surface finish, or a coating.

8. The design system of claim 1, wherein the number of elements is selected from at least one of a passenger seat, an overhead bin, a number of aisles, a seat cushion, a door, a light, a lighting system, an inflight entertainment system, a number of rows of passenger seats, or a seat formation.

9. The design system of claim 1, wherein the element selection is selected from at least one of a text, a voice, or a touch gesture.

10. The design system of claim 1, wherein the number of enhanced elements are identified in the enhanced image using at least one of a color, a highlight, a brightness, a boundary, a pattern change, or an animation.

11. The design system of claim 1, wherein the engineering data defines a number of tolerances for at least one of a physics based parameter, a volume, a material, a dimension, a density, an elasticity, a rigidness, a surface texture, a temperature based material behavior, a size, a location, an orientation, or a weight.

12. The design system of claim 1, wherein a new aircraft is manufactured using the design for the customized image.

13. The design system of claim 1, wherein an existing aircraft is reconfigured using the design for the customized image.

14. A method for generating a change to a design of an interior of an aircraft, the method comprising:
identifying a reference image of the design of the interior of an aircraft;
identifying engineering data for the design;
receiving an element selection of a number of elements in the reference image of the design for modification;
generating an enhanced image of the design using the number of elements in the reference image, the element selection, and the machine learning model system, wherein the number of elements in the enhanced image are a number of enhanced elements;
receiving an element modification for modifying the number of enhanced elements in the enhanced image;
modifying the number of enhanced elements using the element modification that takes into account the engineering data using the machine learning model system to form a customized image of the design with a number of modified elements in place of the number of enhanced elements; and
displaying the customized image on a display system.

15. The method of claim 14 further comprising:
displaying the enhanced image with the number of enhanced elements being graphically emphasized on the display system.

16. The method of claim 14, wherein the machine learning model system comprises a first generative artificial intelligence model trained to generate the enhanced image and a second generative artificial intelligence model trained to generate the customized image.

17. The method of claim 16, wherein the second generative artificial intelligence model is selected from a group comprising a diffusion model, a latent diffusion model, a DALL-E 2 model, and a denoising diffusion probabilistic model.

18. The method of claim 14, wherein generating the enhanced image comprises:
identifying, by the machine learning model system, the number of elements in the reference image using the element selection;
creating, by the machine learning model system, a mask that identifies pixels representing the number of elements identified in the reference image; and
changing, by the machine learning model system, the pixels representing the number of elements to create a number of modified regions for the number of elements to form the enhanced image with the number of enhanced elements, wherein the number of enhanced elements in the number of modified regions is visually distinguished from other elements outside of the number of modified regions in the enhanced image.

19. The method of claim 14, wherein modifying the number of enhanced elements comprises:
identifying, by the machine learning model system, a set of changes to the enhanced elements using the element modification that takes into account the engineering data; and
performing, by the machine learning model system, a diffusion from noise to the customized image using the set of changes identified to generate the customized image with changes to the number of enhanced elements to form the modified elements in the customized image.

20. The method of claim 19, wherein the set of changes to the number of enhanced elements is selected from at least one of a color, a material, a dimension, a shape, a position, a location, an orientation, a surface finish, or a coating.

21. The method of claim 14, wherein the number of elements is selected from at least one of a passenger seat, an overhead bin, a number of aisles, a seat cushion, a door, a light, a lighting system, an inflight entertainment system, a number of rows of passenger seats, or a seat formation.

22. The method of claim 14, wherein the element selection is selected from at least one of a text, a voice, or a touch gesture.

23. The method of claim 14, wherein the number of enhanced elements are identified in the enhanced image using at least one of a color, a highlight, a brightness, a boundary, a pattern change, or an animation.

24. The method of claim 14, wherein the engineering data defines a number of tolerances for at least one of a physics based parameter, a volume, a material, a dimension, a density, an elasticity, a rigidness, a surface texture, a temperature based material behavior, a size, a location, an orientation, or a weight.

25. The method of claim 14 further comprising:
manufacturing a new aircraft using the design for the customized image.

26. The method of claim 14 further comprising:
reconfiguring an existing aircraft using the design for the customized image.

27. A computer program product for generating a change to a design of an interior of an aircraft, the computer program product comprising:
a set of one or more computer-readable storage media; and
program instructions stored on the set of one or more storage media to perform operations comprising:
identifying a reference image of the design of the interior of an aircraft,
identifying engineering data for the design;
receiving an element selection of a number of elements in the reference image of the design for modification;
generating an enhanced image of the design using the number of elements in the reference image, the element selection, and the machine learning model system, wherein the number of elements in the enhanced image are a number of enhanced elements;
receiving an element modification for modifying the number of enhanced elements in the enhanced image;
modifying the number of enhanced elements using the element modification that takes into account the engineering data using the machine learning model system to form a customized image of the design with a number of modified elements in place of the number of enhanced elements; and
displaying the customized image on a display system.

28. An interior design system comprising:
a computer system;
a generative artificial intelligence model system in the computer system; and
a design generator in the computer system, wherein the design generator is configured to perform operations comprising:
identifying a reference image of a design of a platform,
identifying engineering data for the design;
receiving an element selection of a number of elements in the reference image of the design for modification;
generating an enhanced image of the design using the number of elements in the reference image, the element selection, and the machine learning model system, wherein the number of elements in the enhanced image are a number of enhanced elements;
receiving an element modification for modifying the number of enhanced elements in the enhanced image;
modifying the number of enhanced elements using the element modification that takes into account the engineering data using the machine learning model system to form a customized image of the design with a number of modified elements in place of the number of enhanced elements; and
displaying the customized image on a display system.

29. The design system of claim 28, wherein the design is for at least one of an interior, a physical structure, or an exterior for the platform.

30. The design system of claim 28, wherein the platform is selected from a group comprising an aircraft, a commercial airplane, a cargo airplane, a rotorcraft, a tilt-rotor aircraft, a tilt wing aircraft, a vertical takeoff and landing aircraft, an unmanned aerial vehicle, an artificial intelligence controlled vehicle, an electric vertical takeoff and landing vehicle, a personal air vehicle, a surface ship, a cruise ship, a tank, a personnel carrier, a train, a spacecraft, a crewed spacecraft, a space plane, a submarine, a bus, an automobile, a power plant, a bridge, a dam, a house, a manufacturing facility, and a building.
